(19) United States
(12) Patent Application Publication
(10) Pub. No.: US 2014/0360360 A1
(43) Pub. Date: Dec. 11, 2014

(54) METHOD FOR DETERMINING A POSITION OF A PISTON IN A PISTON PRESSURE ACCUMULATOR BY MEANS OF INDUCTIVE SENSORS AND SUITABLY DESIGNED PISTON PRESSURE ACCUMULATOR

(71) Applicant: Robert Bosch GmbH, Stuttgart (DE)

(72) Inventors: Richard Bauer, Zellingen (DE); Christoph Weisser, Gerlingen (DE); Ingo Bork, Lohr (DE); Stefan Weiss, Steinheim/Kleinbottwar (DE); Bernhard Zickgraf, Neckarsulm (DE); Susanne Spindler, Stuttgart (DE)

(73) Assignee: Robert Bosch GmbH, Stuttgart (DE)

(21) Appl. No.: 14/370,024

(22) PCT Filed: Dec. 27, 2012
(86) PCT No.: PCT/EP2012/076946

§ 371 Date: Jun. 30, 2014

(30) Foreign Application Priority Data
Dec. 28, 2011 (DE) 10 2011 090 050 .

(51) Int. Cl. F15B 19/00

(52) U.S. Cl. CPC F15B 19/005
USPC 92/5 R; 92/261

(57) ABSTRACT

The invention relates to a piston accumulator (1) and a method for determining a position of a piston (5) that can be moved inside a housing (3) of the piston accumulator (1). One or more inductive sensors (15) are arranged on an exterior surface (21) of the housing (3) and configured to detect a movement of the piston (5) inside the housing (3) caused by electromagnetic induction. In this way, a determination of the current position of the piston (5), which is technically simple to realise and contact-free, can be implemented and used, for example, to monitor a charge state of the piston pressure accumulator (1).

### BACKGROUND OF THE INVENTION

The present invention relates to a method for determining a position of a piston within a piston pressure accumulator. The invention further relates to a suitably designed piston pressure accumulator. The invention also relates to a method for checking an item of information relating to a state of charge of a piston pressure accumulator, and also to a monitoring apparatus for monitoring a piston pressure accumulator.

Piston pressure accumulators are used for the purpose of storing energy by a fluid being stored under pressure by the compression of gas. For example, piston pressure accumulators are used in hydraulic hybrid vehicles for the purpose of storing energy, which is generated during braking of wheels for example, and of making said energy available again, for example during subsequent acceleration of the vehicle.

In the case of a piston pressure accumulator, a, for example, cylindrical housing can contain a piston, which can be moved in said housing, as a separation element between two partial volumes of the piston pressure accumulator. A compressible gas can be introduced into one of the partial volumes. A non-compressible fluid can be introduced into the other partial volume. In particular, the non-compressible fluid can be introduced into and discharged again from the corresponding partial volume by a suitable valve system in order to store and again release energy mechanically by compressing the compressible gas.

DE 10 2010 001 200 A1 describes a conventional piston pressure accumulator.

In order to be able to determine a state of charge (SOC) of the piston pressure accumulator, that is to say in order to be able to determine how much energy is currently stored in the piston pressure accumulator, measurement variables which determine the energy content, such as the pressure prevailing in the piston pressure accumulator and the temperature prevailing in this case for example, can be measured. Pressure and temperature measurement of this kind is possible using simple sensors.

However, it has been observed that sometimes large inaccuracies can occur when determining the state of charge, in particular under dynamic operating conditions on account of, for example, a latency time of the temperature measurement.

As an alternative, the state of charge of a piston pressure accumulator can be ascertained on the basis of the current position of the piston within the housing of the piston pressure accumulator. The position of the piston can be ascertained in a conventional manner, for example, by end position switches which ascertain the end position of the piston at one and/or other end of the accumulator within the housing of the piston pressure accumulator, for example by means of a switching rod. As an alternative, the travel or location of the piston within the housing can be sensed, for example, by means of a piston rod, a cable-pull measurement system or an ultrasound travel measurement system.

However, systems of this kind for determining the current position of the piston require a high level of structural expenditure. In particular, it may be necessary to integrate components, such as end position switches or a piston rod for example, into the internal volume of the piston pressure accumulator, wherein it may be necessary to mechanically and/or electrically connect components of this kind to the outside.

### SUMMARY OF THE INVENTION

The method proposed in this document for determining a position of a piston within a piston pressure accumulator and also a correspondingly equipped piston pressure accumulator can allow the current position of the piston within the piston pressure accumulator to be determined with a high degree of accuracy and, despite this, a low level of structural expenditure.

In addition, an item of information relating to the state of charge of the piston pressure accumulator can be ascertained, and therefore an item of information, which is obtained in a different way, relating to said state of charge can be checked, on the basis of the position, which is determined in this way, of the piston within the piston pressure accumulator. The state of charge of the piston pressure accumulator can therefore be monitored in a more reliable manner.

According to a first aspect of the invention, a piston pressure accumulator is proposed, in which a piston can move within a housing. In this case, at least one inductive sensor is arranged on the outside of a casing surface of the housing and is designed to detect a movement of the piston, which is formed using an electrically conductive and/or ferromagnetic material, in the interior of the housing on account of electromagnetic induction.

A piston pressure accumulator of this kind allows a method for determining a current position of the piston within the piston pressure accumulator with the aid of the inductive sensor which is fitted to the outside of the housing. In this case, the position of the piston can be derived from a changing electromagnetic induction on account of the piston which is moving in the interior of the housing.

One advantage of the proposed piston pressure accumulator and, respectively, of the proposed method for determining the current piston position, which method can be carried out using said piston pressure accumulator, can be seen in that no measurement sensors or other components need to be arranged within the accumulator volume of the piston pressure accumulator.

In order to determine the current position of the piston, one or more inductive sensors can be arranged on the outside of the housing of the piston pressure accumulator. A position of the piston which changes in the interior of the housing can be detected with the aid of the inductive sensor or the inductive sensors. The inductive sensor or the inductive sensors can identify the presence or a movement of the piston in the interior of the housing on account of a measurement of the magnetic induction in this case.

In this case, an inductive sensor can employ various physical measurement principles and can be based, in particular, on electromagnetic induction, damping or changing the frequency of a resonant circuit or a coil.

By way of example, the inductive sensor can be designed as a differential transformer, inductive travel sensor, eddy-current sensor or inductive proximity switch.

The induction sensor generally measures, for example in the vicinity of a measurement coil, a change in the magnetic field on account of a moving, electrically conductive and/or ferromagnetic object. On account of its manner of operation which is based on the induction principle, the inductive sensor can therefore measure a movement of the piston in a contact-free and consequently wear-free manner.

Specifically, based on the piston pressure accumulator proposed in this document, an inductive sensor can emit, for example, an electromagnetic field which causes an eddy current in a piston which is moving past or in the electrically conductive material which is provided in said piston. In this case, energy is drawn from an oscillator which is provided in the inductive sensor, it being possible for this to be detected with the aid of a suitable sensor system and converted into measurement signals. On account of the measurement signals which are supplied by the inductive sensor, an item of information relating to the current position of the piston within the housing can ultimately be derived when said piston moves past the sensor.

The housing of the piston accumulator is preferably formed, at least in subregions of the casing surface, using an electrically insulating and/or diamagnetic material.

By choosing a material of this kind for the housing or at least subregions of the housing, it is possible to prevent the inductive sensor which is arranged on the outside of the casing surface of the housing from being electromagnetically shielded in relation to the interior of the housing.

On account of the housing being composed, at least in the subregions in which an inductive sensor is arranged on the casing surface of said housing, of a material which is neither electrically conductive nor inherently ferromagnetic, it is possible for the inductive sensor to detect changes in a magnetic field, as are caused by the piston which moves in the interior, through a wall of the housing.

In order to precisely ascertain the current position of the piston, several inductive sensors can be arranged on the casing surface of the housing. In this case, the more sensors are provided on the housing, the more accurately the current position of the piston in the interior of the housing can be detected.

The several inductive sensors can be arranged along a line parallel to a movement direction of the piston. Owing to an arrangement of the inductive sensors in this way, the measurement signals which are detected by the inductive sensors can be evaluated in a simple manner.

The above-described method for determining a position of the piston within a piston pressure accumulator can advantageously be used in order to check an item of information relating to the state of charge of the piston pressure accumulator on the basis of the determined position of the piston. A method of this kind can be executed in a monitoring apparatus for monitoring the piston pressure accumulator.

By way of example, during normal operation of the piston pressure accumulator, the state of charge of said piston pressure accumulator can be determined only on account of other measurement variables, such as a pressure and a temperature of the fluid or gas which is stored in the piston pressure accumulator for example. The state of charge can be determined in a simple manner and with a generally sufficient degree of reliability on the basis of measurement variables of this kind which are simple to ascertain. However, in certain time intervals or, for example, under specific operating conditions of the piston pressure accumulator, it may be advantageous to monitor, to calibrate or to state more precisely the state of charge measurement which is carried out in this way by additionally ascertaining an item of information relating to the current position of the piston within the piston pressure accumulator. To this end, a calculation model containing the data which is provided by the inductive sensors and relates to the current position of the piston can, for example, be initialized, calibrated and/or monitored. This additional information allows more accurate determination of the state of charge of the piston pressure accumulator and/or allows the plausibility of the state of charge which is ascertained with other measurement methods to be checked. This can be used to the effect that, for example, the so-called SOC swing can be better utilized. That is to say a charging process does not need to be terminated, for example, as early as at a state of charge of, for example, 90% in order to ensure a sufficient safety reserve, but rather can be continued, for example, up to a state of charge of 98%. As a result, the energy content of the piston pressure accumulator can be utilized more efficiently.

It should be noted that possible features and advantages of embodiments of the invention are described in this document partially with reference to the method for determining the position of the piston within the piston pressure accumulator, partially with reference to the method for checking the information relating to the state of charge of the piston pressure accumulator, and partially with reference to a correspondingly designed piston pressure accumulator. A person skilled in the art will recognize that the features can be combined with one another and/or interchanged in a suitable manner in order to arrive at further embodiments of the invention and possibly to achieve synergy effects.

### BRIEF DESCRIPTION OF THE DRAWINGS

Embodiments of the invention will be described below with reference to the appended drawing. Neither the description nor the drawing is intended to be interpreted as restricting the invention.

FIG. 1 shows a sectional side view through a piston pressure accumulator according to one embodiment of the present invention.

The FIGURE is merely schematic and not true-to-scale.

### DETAILED DESCRIPTION

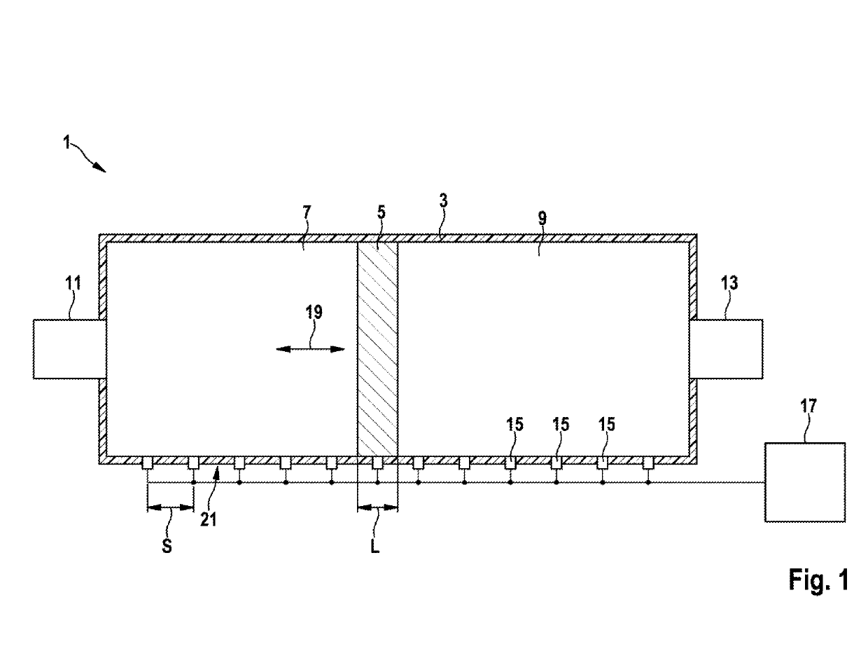

FIG. 1 shows a piston pressure accumulator 1 according to one embodiment of the present invention. The piston pressure accumulator 1 has a housing 3 of lightweight design which is largely composed of glass or carbon fiber-reinforced plastic (GFRP or CFRP). Said GFRPs or CFRPs are substantially made up of electrically non-conductive glass fibers and a non-conductive plastic matrix, for example in the form of an artificial resin. The housing can have, for example, a cylindrical geometry with a diameter of, for example, 10-30 cm and a length of, for example, 50-300 cm.

A piston 5 which is composed of an electrically conductive material, such as a metal, for example aluminum, for example, is arranged within the housing 3. The piston 5 serves as a separation element between two partial volumes 7, 9 within the housing 3 and seals off said partial volumes from one another. In this case, the piston 5 can be moved along a movement direction 19, which corresponds to the center axis of the cylinder of the housing 3, with the result that the partial volumes 7, 9 can be varied.

A non-compressible fluid, such as a liquid, in particular oil, for example, can be introduced into or discharged from a first partial volume 7, for example, by means of a valve system 11. A compressible fluid, such as a gas for example, can be introduced into or discharged from the other partial volume 9 by means of a valve system 13. In this case, the piston 5 can be moved along the movement direction 23 depending on the quantity of non-compressible fluid which is introduced into the partial volume 7, and can store energy by building up a pressure in the compressible fluid which is contained in the second partial volume 9.

One or more inductive sensors 15 is/are arranged on a casing surface 21 of the cylindrical housing 3 of the piston pressure accumulator 1. When several inductive sensors 15 are used, said inductive sensors are arranged one behind the other in a direction parallel to the movement direction 19 of the piston 5. A distance “s” between adjacent inductive sensors 15 in this direction may be smaller than or equal to or greater than a length “L” of the piston 5 in the same direction depending on, for example, the degrees of accuracy which are intended to be achieved when determining the position of the piston and on the minimum distances between adjacent sensors that have to be maintained in order to prevent the sensors having a negative influence on one another.

The inductive sensors 15 are each connected to a monitoring apparatus 17 and can transmit their measurement signals to said monitoring apparatus 17. The current position of the piston 5 can be discretely determined by the inductive sensors 15 which are distributed over the length of the piston accumulator 1.

This information can be used by the monitoring apparatus 17, for example, in order to initialize a calculation model, in which the state of charge of the piston accumulator 1 is calculated on the basis of physical measurement variables such as the pressure prevailing in the piston accumulator 1 and the temperature which prevails in this case for example, and/or to compensate and to correct said calculation model during operation of the piston accumulator 1. As a result, a considerably higher degree of accuracy of the calculated value of the current state of charge can be obtained, in particular under dynamic operating conditions.

1. A piston pressure accumulator (1), comprising:
a housing (3), and
a piston (5) movable within the housing (3), and
at least one inductive sensor (15),
wherein the piston (5) is formed using an electrically conductive and/or ferromagnetic material, and
wherein the inductive sensor (15) is arranged on an outside of a casing surface (21) of the housing (3) and is configured to detect a movement of the piston (5) in an interior of the housing (3) on account of electromagnetic induction.

2. The piston pressure accumulator as claimed in claim 1, wherein the housing (3) is formed, at least in subregions of the casing surface (21), using an electrically insulating and/or diamagnetic material.

3. The piston pressure accumulator as claimed in claim 1, wherein one or more inductive sensors (15) are arranged on the casing surface (21) of the housing (3).

4. The piston pressure accumulator as claimed in claim 3, wherein the inductive sensors (15) are arranged along a line parallel to a movement direction (19) of the piston (5).

5. A method for determining a position of a piston (5) within a piston pressure accumulator (1), wherein the piston pressure accumulator (1) has a housing (3) and a piston (5) movable within the housing (5), characterized in that the method comprises:
determining the position of the piston (5) by means of at least one inductive sensor (15).

6. The method as claimed in claim 5, wherein the position of the piston (5) is derived from a changing electromagnetic induction on account of the piston (5) which moves in an interior of the housing (3).

7. A method for checking an item of information relating to a state of charge of a piston pressure accumulator (1),
characterized in that the method comprises the following steps:
determining a position of a piston (5) within the piston pressure accumulator (1) in accordance with a method as claimed in claim 5, and
checking the information relating to the state of charge of the piston pressure accumulator (1) taking into account a determined position of the piston (5).

8. The method as claimed in claim 7, wherein the state of charge is ascertained on the basis of a measured pressure and a measured temperature of a fluid within the piston accumulator, and the state of charge which is ascertained in this way is checked taking into account the previously determined position of the piston.

9. A monitoring apparatus (25) for monitoring a piston pressure accumulator (1), characterized in that the monitoring apparatus (25) is configured to carry out a method as claimed in claim 5.
